(19) United States
(12) Patent Application Publication
(10) Pub. No.: US 2010/0254813 A1
(43) Pub. Date: Oct. 7, 2010

(54) WINCH SERVICING OF WIND TURBINES

(75) Inventors: Mark DAWSON, Boise, ID (US); Jack WALLACE, Yucaipa, CA (US)

Correspondence Address: BANNER & WITCOFF, LTD., 1100 13th STREET, N.W., SUITE 1200, WASHINGTON, DC, 20005-4051, US

(73) Assignee: FRONTIER PRO SERVICES, Banning, CA (US)

(21) Appl. No.: 12/417,019

(22) Filed: Apr. 2, 2009

(51) Int. Cl. F03D 11/00; B23P 6/00; B66D 1/00

(52) U.S. Cl. 416/146 R; 29/889.1; 254/264

(57) ABSTRACT

A wind turbine with a nacelle, a base, and a plurality of blades operably connected around a turbine hub is described. The wind turbine is configured to house a winch mechanism for servicing a portion of a blade. The winch mechanism may have any of a number of components or configurations. Features included as part of a winch mechanism are a winch, a cable, pulleys and a securing element. Methods of servicing blades of a wind turbine with the winch mechanism including repair, removal, installation, replacement of the blades is also described. The winch mechanism may be removably or statically housed in the wind turbine for performing of the described methods and may be mounted by hoisting through the tower. A device for temporarily applying attachment points to a wind turbine blade, such that the attachment points can be remotely removed, is also described.

### FIELD OF THE INVENTION

The invention relates generally to wind turbines. More specifically, the invention relates to servicing of wind turbines including the removal or installation of blades of wind turbines.

### BACKGROUND OF THE INVENTION

Wind turbines are known. They are renewable energy devices that may provide energy with minimal to zero environmental affects. Global energy demand continues to increase as a result of continued industrialization and population increase. Likewise, environmental concerns also continue to play more significant roles in economies and industries across the globe including concerns relating to air quality, draining of natural resources, and global warming, to name a few. Accordingly, innovation relating to renewable energy methods and devices and wind turbines in particular is of significant interest, importance and attention. Wind turbines and methods of operating, maintaining, controlling and otherwise using wind turbines are of significant interest and research as they relate to energy production and consumption as well as the preservation of the environment and other natural resources.

### BRIEF SUMMARY OF THE INVENTION

To overcome limitations in the prior art described above, and to overcome other limitations that will be apparent upon reading and understanding the present specification, the present invention is directed to wind turbines and wind turbine repair.

A first aspect of the invention provides a wind turbine with a nacelle, a base, and a plurality of blades operably connected around a turbine hub. The wind turbine is configured to house a winch mechanism for removing a portion of a blade. Winch mechanism may have any of a number of components or configurations. Features commonly included as part of a winch mechanism are a winch, a cable, and a securing element. Various pulleys and related structures for changing the direction of a tensioned cable are also commonly used. The winch and/or winch mechanism may be permanent or removable and its components may be housed in various locations including the nacelle, the turbine hub, the tower, and the base as desired. Additionally, the winch mechanism may be removably installed when servicing is desired by lifting or hoisting components to the nacelle, the hub or blades of the wind turbine or by mounting to an anchor point or vehicle on the ground.

A second aspect of the invention provides a method for servicing or removal of a portion of a blade of a wind turbine. This method may include the steps of attaching a securing element to a portion of a blade, disconnecting the portion of the blade from a turbine hub, and supporting and lowering the disconnected portion of the blade using a cable attached to a winch mechanism operably connected to a securing element The winch mechanism may include a winch housed by the wind turbine. The portion of the blade may be an entire blade or a specific portion of a blade such as a blade tip of an extendable or variable length blade. A single blade of a wind turbine or multiple blades of a wind turbine may be serviced.

A third aspect of the invention provides a method for installing of a portion of a blade of a wind turbine. This method may include the steps of attaching a securing element to a complimentary blade securing element housed by a portion of a blade, hoisting a portion of the blade to the turbine hub using a winch mechanism and connecting the portion of the blade to the turbine hub. The winch mechanism may include a winch operably connected to the portion of the blade through the securing element to support and raise the portion of the blade. The portion of the blade may be an entire blade or a specific portion of a blade such as an extendable blade section of an extendable or variable length blade. A single blade of a wind turbine or multiple blades of a wind turbine may be serviced.

Other aspects of the invention include variations and configurations of wind turbines and methods for servicing wind turbines as are described herein.

### BRIEF DESCRIPTION OF THE DRAWINGS

A more complete understanding of the present invention and the advantages thereof may be acquired by referring to the following description in consideration of the accompanying drawings, in which like reference numbers indicate like features, and wherein:

FIG. 1 illustrates an example of variable blade wind turbine.

FIG. 2 illustrates an example of fixed blade wind turbine and an associated transformer.

FIG. 3 illustrates an exemplary diagram of an arrangement of components of a wind turbine.

FIGS. 4A-4B are illustrative enlarged diagrams of an extendable tip of a variable length blade during serving according to the described methods.

FIGS. 5-7 are illustrative enlarged diagrams of various configurations and arrangements for servicing a turbine blade 10.

FIGS. 8A-8B are illustrative diagrams of portions of a variable length wind turbine with replaceable tips.

FIGS. 9A-9B are illustrative diagrams of portions of a wind turbine during a tip replacement process.

FIG. 10 is an illustrative diagram of a portion of a wind turbine including a target blade.

FIGS. 11A-11C are illustrative diagrams of a method and device for temporarily fixing attachment points to a blade of a wind turbine.

FIGS. 12A-12C are further illustrative diagrams of a method and device for temporarily fixing attachment points to a blade of a wind turbine.

### DETAILED DESCRIPTION OF THE INVENTION

In the following description of the various embodiments, reference is made to the accompanying drawings, which form a part hereof, and in which is shown by way of illustration various embodiments in which the invention may be practiced. It is to be understood that other embodiments may be utilized and structural and functional modifications may be made without departing from the scope of the present invention.

Wind turbines create power proportional to the swept area of their blades. Increasing the length of a wind turbine's blades increases the swept area. Accordingly, more power can be produced or captured. A wind turbine's generator, gears, bearings, and support structure are typically designed around the expected wind load and power production characteristics. At low wind speeds very long blades are desirable to get as much power as possible out of the available wind. At high wind speeds a wind turbine must control the power production and the mechanical loads developed so as to prevent breaks, cracks and other destruction to the wind turbine. Eventually, if the wind speeds become high enough, the turbine must shut down to avoid damaging components, so short blades are desirable to keep the turbine producing power in high winds.

The choice of a rotor diameter for a wind turbine is a design trade-off between energy production in low winds and load limitation in high winds. Wind turbine manufacturers often sell a variety of rotor sizes for a given wind turbine model. The rotor sizes are optimized for sites that have a low, medium, or high annual average wind speed. The rotor size selected is always a compromise, and there are conditions in which the turbine does not perform optimally because the rotor is too big or too small. Typical wind speeds and standard deviation (max and min wind speeds) at given locations worldwide are generally known. This information is often seen in charts or graphs. For example, various charts and graphs illustrating wind speeds across the United States are known and may be helpful to wind turbine designers in designing wind turbines for a given location in the United States or elsewhere across the globe.

A variable length wind turbine blade allows for a large diameter in low winds and a small diameter in high winds. This is accomplished by having a root portion and a tip portion of the blades. The tip portion may be extended or retracted, depending on the amount of wind present. With any turbine, but especially with a variable length blade turbine, the blades must sometimes be removed for replacement or repair. Using a crane is very expensive for simple repairs. It would be advantageous to have a method of mounting a winch or lift for hoisting blades or other parts for repair.

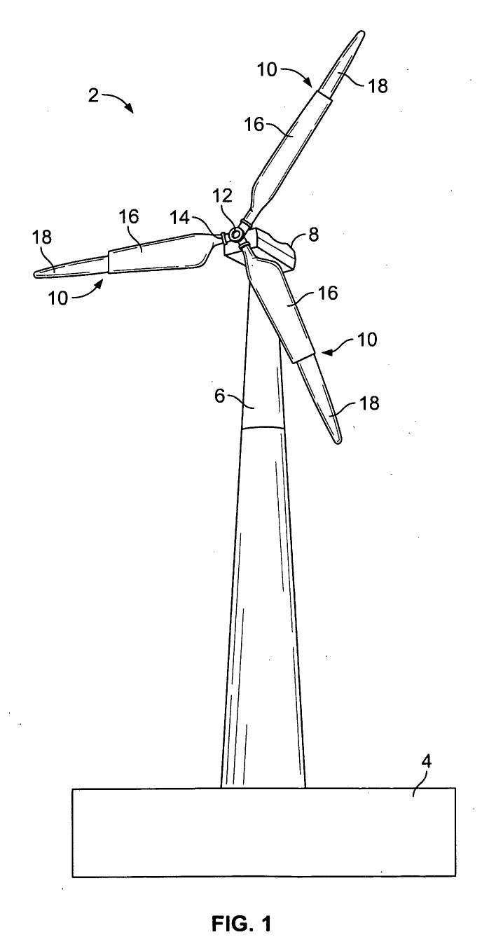

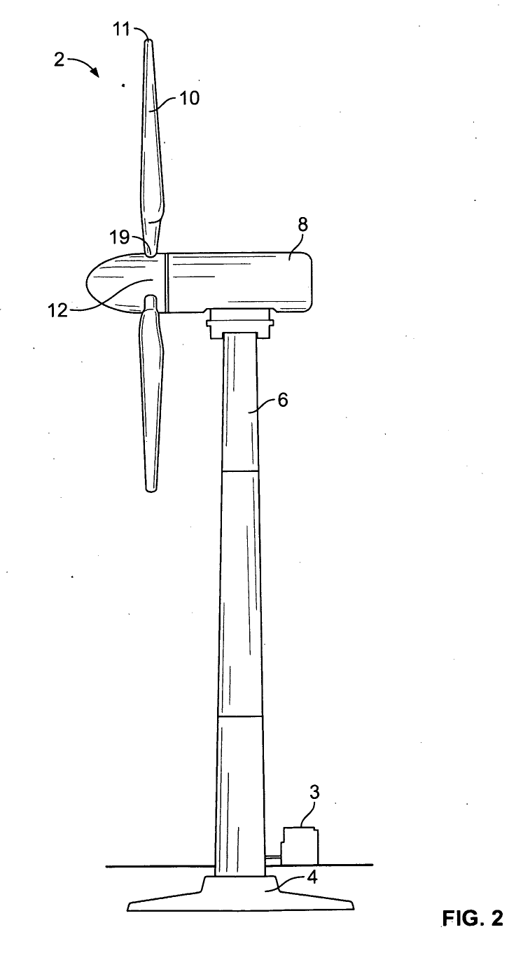

FIG. 1 illustrates an example of wind turbine 2. The wind turbine 2 of FIG. 1 may be considered a variable length blade wind turbine design. The variable length rotor blade of the present invention is described herein for use with an electricity-producing wind turbine 2 as shown in FIG. 1. The wind turbine 2 consists of a foundation 4, a tower 6, a nacelle 8, and a number of variable length blades 10 according to the present invention. There are typically a plurality of blades 10 (two, three, four etc.) on a power producing (capturing) wind turbine 2. Blades 10, regardless of whether they are fixed or variable length, may generally be described as having a tip end 11 and a root end 19. The blade tip 11 refers to the angularly most outward region of the blade 10 as is seen FIGS. 1 and 2. The root end 19 may be generally described as an end or region opposing the tip end 11. As such, the root end 19 is the angularly inward most region of the blade 10 and attaches to the turbine hub 12.

The blades shown in FIG. 1 include an extendable blade section 18 and a fixed blade section 16. The blades 10 are attached to a hub 12 by a bolt flange 14. Alternatively, the blades 10 can incorporate studs that are embedded in the structure of the blade 10 and bolted to the hub 12. The bolt flange 14 on most wind turbines 2 is one of several standard sizes so that retrofitting existing wind turbines 2 with new blades 10 is relatively simple. U.S. Pat. No. 4,915,590, the teachings of which are incorporated herein by reference, describes among other things various types of blade-hub connections.

Continuing with FIG. 1, the variable length blades 10 consist of two portions. There is a fixed blade section 16 which is rigidly attached to the hub 12 and a movable blade section 18 which can be extended or retracted relative to its respective fixed blade section 16. The movable blade section 18 may be movable into a number of positions including an extended position and a retracted position. As the blades are extended, the effective diameter of the wind turbine's rotor increases. As the blades are retracted, the diameter decreases. Power production is proportional to the rotor diameter squared so that a small change in rotor diameter can provide a relatively large change in power output. Furthermore, many structural loads are proportional to rotor diameter raised to the fifth power (if the rotational speed remains constant as the blade diameter is increased) so that a dramatic reduction in loads is possible when the blades are retracted. An example of a variable length wind turbine can be found in U.S. Pat. No. 6,902,370 to Dawson et al., entitled “Telescoping Wind Turbine Blade.” Applicants hereby incorporate by reference U.S. Pat. No. 6,902,370, in its entirety.

The rotor blades as shown in FIGS. 1 and 2 may be formed of any of a variety of suitable materials known to be used in the art. For example, rotor blades on large wind turbines are often made of glass fiber reinforced plastics (GRP), i.e. glass fiber reinforced polyester or epoxy. Reinforcing materials such as carbon fiber or aramid may also be used in rotor blades in certain instances. Steel and aluminum alloys may also be used for rotor blades especially small wind turbines. Wood, wood-epoxy or wood-fiber-epoxy composites also may be utilized. Various other materials may be used for the rotor blades as is known in the art.

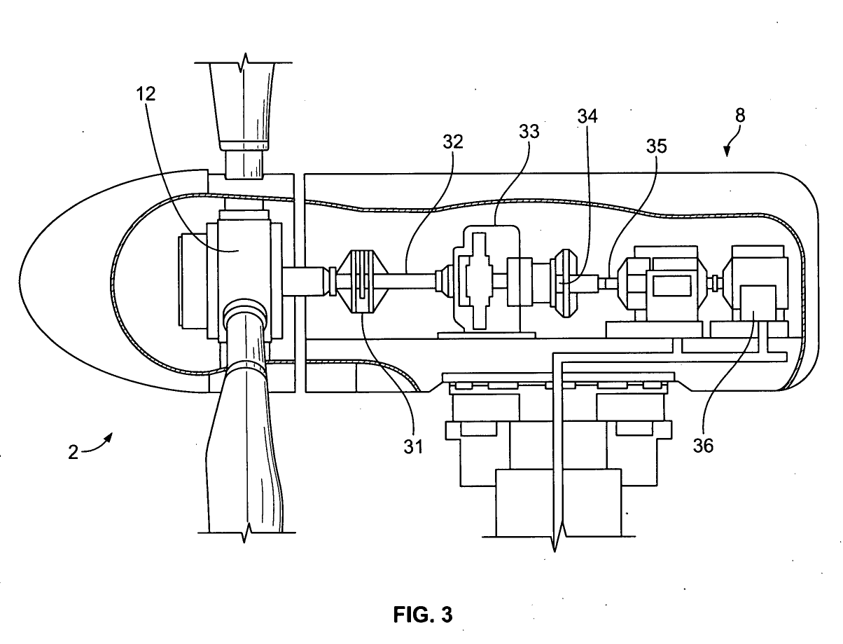

FIG. 2 illustrates an example of another arrangement of a wind turbine 2 and an associated transformer 3. For clarity and understanding, the wind turbine shown in FIG. 2 may generally be referred to as a fixed length blade wind turbine 2. Like the wind turbine 2 of FIG. 1, the wind turbine illustratively shown in FIG. 2 includes a variety of components known in the art with respect to wind turbines. Several turbine blades 10 are configured about a turbine hub 12 and are caused, depending on wind characteristics, to rotate about the turbine hub 12 thereby rotating one or more shafts or similar force transfer elements and components housed in the wind turbine 2. The nacelle 8, an example of which is shown in FIG. 3, often houses a variety of components for capturing, redirecting and/or utilizing the wind so as to generate power for eventual use and distribution including brakes, various shafts, gears, gearboxes, generators and various other components known in the art. As shown and similar to FIG. 1, nacelle 8 may sit on a tower 6 which often supports the power generating/harnessing portions of the wind turbine including for example the nacelle 8, the turbine hub 12 and the turbine blades 10 as well as other related components vertically above a reference surface. Similar to FIG. 1, tower 6 is supported by foundation 4.

FIG. 3 illustrates an exemplary arrangement of components of a wind turbine. For reference and understanding, FIG. 3 illustratively shows one configuration of certain components of the nacelle 8. Components housed in the nacelle 8 many include numerous variations and configurations known in the art. One such illustrative configuration is shown in FIG. 3. In operation, turbine hub 12 is rotated as a result of forces from the wind being applied to the turbine blades 10 (e.g. lift force). This force is transferred through the shown components of the nacelle 8 to a generator 36 where it is converted from rotational (kinetic) energy to electrical energy.

In particular in the configuration of FIG. 3, turbine hub 12 is movably linked to the internal components of the nacelle 8 for use in power generation or capture and control of rotation, positioning and/or movement of the turbine hub 12. One or more shafts are commonly used to transfer the rotational energy through the wind turbine such that it can be converted into electrical energy for storage, distribution or use. Low speed shaft 32 and high speed shaft 35 are shaped and configured so as to provide desired rotational energy transfer characteristics. As is commonly understood in the art, shaft circumference is often directly related to the desired rotational characteristics. Brakes 31, 34 are used for stopping or slowing associated shafts in cases of power overload, system failure, upon controller desire or in anticipation of maintenance etc. The gearbox 33 uses gears housed within to increase the speed of the shaft when one moves from the turbine hub 12 to the generator. As is known, increased shaft speed allows the shaft to have a higher rotational speed and allows the generator 36 to be turned at a faster speed thereby allowing power to be generated in a more efficient manner in relation to each turbine hub 12 rotation.

As mentioned, the configuration illustratively shown in FIG. 3 is one exemplary configuration of certain power generation/capture components of a wind turbine 2. Various other components not shown are known to also be utilized depending upon the characteristics of the wind turbine 2. For example, many wind turbines 2 also include one or more associated electronic control units for monitoring and control of the wind turbine. Additionally, a yaw controller may also be utilized in alignment of the turbine with the direction of the wind such that the current wind conditions are optimized to maximize power capture, minimize stress, strain or fatigue on the wind turbine including its blades 10 or other user or controller desired characteristics. Additionally, various other electrical components may be housed in the tower 6, nacelle 8 or other locations to facilitate transfer of power from the generator 36 to the transformer 3 etc. While the electrical control unit, the yaw controller, and the other electrical components described above are not shown herein, they are well known in the art and can take any form known in the art.

Wind turbines can be configured in a number of specific designs with varied characteristics based upon desire and need. A particular wind turbine may have varying designs traits based upon wind conditions, extent of surface footprint available, soil characteristics, placement such as being located alone or in a wind farm, power output requirements etc. While various specific wind turbine designs exist, wind turbines in general are sometimes susceptible to damage in light of their very function and purpose. In light of the properties of the materials preferred for turbine blades, the orientation of the blades and the wind, and other environmental conditions, wind turbines may develop holes, cracking or breaking especially the turbine blades 10. Many turbine blades 10 are made, for example, from fiberglass for its preferred characteristics and properties. Accordingly, the orientation of the glass fibers in horizontal axis wind turbines (e.g. wind turbine 2), can leave this weakened region susceptible to breaking or cracking.

In order to easily change, repair or even install blades 10, a winch may be mounted (removably or non-removably) in the hub 12, tower 6, nacelle 8 or at the base of the wind turbine. Within or on the hub of the turbine 12 or nacelle 8, provisions are made to guide the winch cable 126 for the removal and installation of blades 10, extendable blade sections 18 or blade drive components. An alternative to statically and non-removably housing the winch in the hub or nacelle 8 is to provide a way to attach a winch within the nacelle 8 or hub 12 by bringing the winch up the turbine tower 6 when needed. Further, a winch may also be mounted on the base (including the ground at the base of the tower) with provisions for guiding the cable in the hub 12.

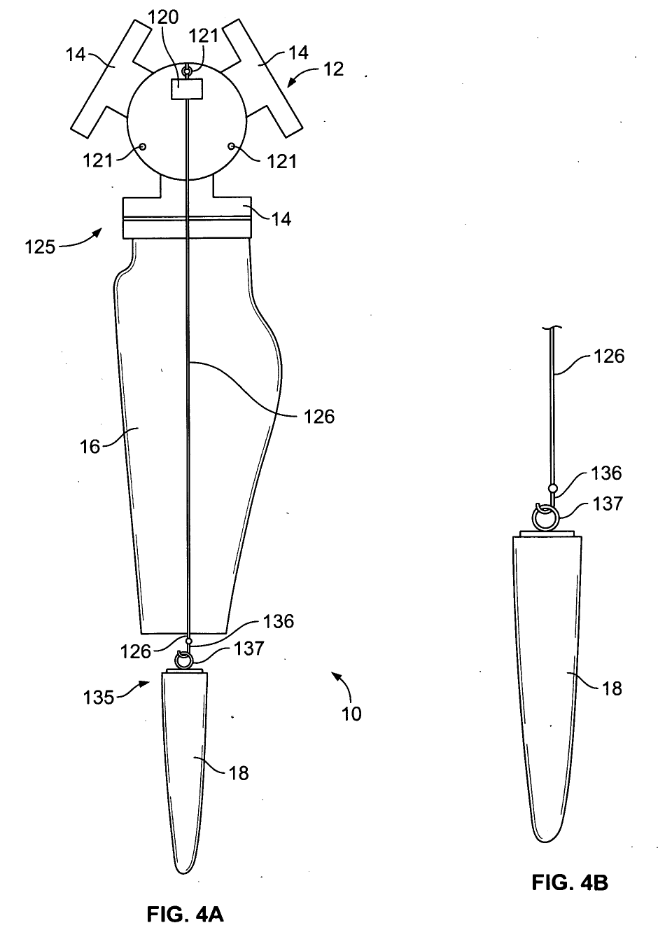

FIG. 4 is an illustrative enlarged diagram of an extendable tip of a variable length blade during servicing (repair, removal, installation, replacement, etc.) according to the described methods. In particular, FIG. 4 illustrates a winch mechanism 125 for servicing a wind turbine blade 10. Consistent with the structure and purposes described herein, it is known that a winch mechanism 125 may be comprised of various features arranged, aligned, positioned and utilized in any number of manners and arrangements (despite not being shown in the figures) to accomplish the desired servicing characteristics associated with the features and characteristics of a given wind turbine 2 (not shown here). In the illustrative example winch mechanism 125 depicted in FIG. 4, the winch mechanism 125 includes a winch 120 housed on mounting hardware 121 in the turbine hub 12 and a cable 126 operably connecting the winch 120 to the portion of the blade to be serviced, here, extendable blade section 18.

In particular, mounting hardware 121, here anchor point 121, is fixed in three positions about the turbine hub 12. Each of the three anchor points 121 is positioned opposite the mounting flange 14 of a particular blade 10 so as to sit in a location to facilitate raising, lowering and supporting the blade when the winch 120 is attached and the winch mechanism 125 is operated. In the configuration of FIG. 4, winch 120 is a removable winch. Accordingly, removable winch 120 may be attached to one of the anchor points 121 on the turbine hub 12 for servicing of a particular blade 10. Operably attached and running from the removable winch 120 is high strength cable 126.

Cable 126 may be composed of various materials. Generally, cable 126 will possess significant strength characteristics since cable 126 will need to be strong enough to support the wind turbine blade 10 or a portion thereof such as an extendable blade section 18. Additionally, as will be described in more detail later, cable 126 often will be ductile, bendable and flexible so as to allow the cable 126 to operably wind about a pulley and move while under load. In FIG. 4, a first end of cable 126 is shown as being connected to removable winch 120 at what may be referred to for clarity as the “twelve o'clock” or “top position” of the turbine hub 12 and hanging down similar to a plumb line. The opposing end of the cable 126 is secured to a portion of the blade 18 by a securing mechanism 135.

Winch lines are known. Cable 126 may be any of steel cable, synthetic cable or webbed strapping. Steel cable is a traditional material for winch lines that has been used for years. Synthetic cable, sometimes referred to as Plasma, has become popular in recent years although it is typically more expensive than steel cable. While synthetic cable typically has a tensile strength similar to steel cable of the same diameter, synthetic cable has more stretch than the steel cable, and may be easier to cut on sharp edges. Strapping including webbed strapping may also be used. Winch straps or webs are very long straps. While, these straps are sometimes used as alternatives to synthetic cables, they are often only applicable for light jobs (e.g., up to 5,500 kg or 12,000 lbs). Cable 126 may be formed of any of steel cable, synthetic cable or webbed strapping or any other winch cabling known in the art.

Winches are known. As described previously, the winch shown in FIG. 4 is a removable winch 120 as it may be attached and removed depending on the operating state of the wind turbine or the particular blade that needs servicing. Generally, winches are mechanical devices used to pull in (wind up) or let out (wind out) or otherwise adjust the tension of cables, wires, ropes and the like. Simple winches consist of a spool and a crank. Sometimes the spool is referred to as the winch drum. Other variations of winches include gear assemblies. Winches may be powered by electric, hydraulic pneumatic or internal combustion drives. Additionally some winches include solenoid brakes and/or a mechanical brake or a ratchet and pawl device that prevents unwinding unless the pawl is retracted. For example, a non-freewheeling worm-gear winch is an example of a winch with characteristics that prevent inadvertent backtracking of the winch. Some examples of winches are Griphoist or Tirfor Hand Winches, chain winches and cable winches.

Winches in wind turbine applications typically have high strength features especially when the wind turbine is large and the blades are large and heavy. In certain applications as is described, the winch will be a removable winch 120 and in other configurations they are permanently housed within a component of the wind turbine. Whether the winches are removable or permanent may have an effect on their size and strength capabilities. Removable winches are typically built to be smaller to make them lighter to facilitate movement of the winch from position to position. For example, a winch may be designed with desirable traits and features for hoisting the winch up the tower 6 of a wind turbine 2 as the tower 6 may have a tight fitting space through which the winch may need to travel to reach the nacelle 8 or turbine hub 12.

Like winches, securing mechanisms are known. Various mechanisms are known by those skilled in the art for connecting cables, ropes, chains or other cords for lifting and supporting large and heavy structures in industry. Securing mechanisms, as shown in FIG. 4 often include a securing element 136 that is configured to grasp, hold, support, stick or otherwise attach to the blade 10 or a specific portion of the blade 16 or 18. Further, the blade 10 itself may be configured with features to facilitate secure attachment of the cable 126. Additionally, because installations, repair and other servicing of wind turbine blades 10 are ideally performed as quickly as can be done in a safe and effective manner, securing mechanisms can facilitate an expeditious connection of the winch mechanism 125 including the cable 126 to the blade 10. Thus, blades 10 may be configured with a securing element receiver 137 that may be configured in complimentary fashion to engage and connect or secure to the securing element 136 attached to the cable 126.

FIG. 4A (and an enlarged view of extendable blade section 18 in FIG. 4B) show illustrative examples of a securing mechanism 136 including a securing element 136 in the shape of a hook attached to a security element receiver 137 in the shape of a stirrup mounted on the extendable blade section 18. Likewise, the blade 10 may also be configured to house a plurality of security element receivers 137 shaped as stirrups or lifting eyes, attached to the blade 10 bolts or bolt holes. Thereby, hooks 136 could engage and secure the blade by hooking on to security element receivers 137. Also, securing element 136 may be a fastener having bolts or screw like features and may be affixed to a complimentary surface 137 of the blade 10 to secure the cable 126 to the blade 10. Numerous configurations and specific structures as are known in the art may be used as securing element 136, securing element receiver 137 and/or securing mechanism 135.

Removal of a portion of a blade 18 utilizing a winch mechanism 125 in the configuration illustratively shown in FIGS. 4A-B may include the following steps. First, the removable winch 120 is mounted on one of the anchor points 121. Once the winch 120 is in place the cable 126 may be extended so as to be positioned in preparation for unscrewing bolts or otherwise releasing other securing features that hold the portion of the blade 18 in place. Before or coincidently, the securing mechanism is attached in part or completely so as to be able to provide support for the portion of the blade 18 as the bolts of other securing features are released so that the portion of the blade 18 does not fall to the ground. Once the securing mechanism 125 is engaged so as to provide sufficient support to hold the portion of the blade 18 in place, any remaining bolts or other securing features may be disengaged or released so that the securing mechanism 125 via the cable 126 provides support for the portion of the turbine blade 18. Because the winch 120 is fixed or mounted on the turbine hub 12, it is recognized that the tower 6, base 4 and other wind turbine support structures also provide support for the blade portion 18 via winch mechanism 125. However, for clarity and ease of explanation discussion is focused on operation of the winch mechanism 125 in providing support.

Once the portion of the blade 18 is secured to the cable 126 via the securing mechanism 135, the operation of the winch 120 will control raising, lowering and any other movement of the portion of the blade 18. In general, the winch mechanism 125 provides support for the blade 10 (or a portion there of) and can be driven to lift or lower the blade 10 (or portion thereof). For example, to raise or lower the portion of the blade 18, winch 120 is powered and rotated and thereby causes the cable 126 to be effectively shortened or elongated accordingly. When the cable 126 is shortened or recoiled, the portion of the blade secured to the cable at the securing mechanism 135 is caused to be raised. Likewise, when cable 126 is lengthened by allowing more cable or more slack out, the portion of the blade secured to the cable at the securing mechanism 135 is caused to be lowered. Accordingly, once the portion of the blade is secured to the cable 126, the portion of the blade 18 can be moved, adjusted and positioned during repair, removal, and installation etc., of the portion of the blade 18.

After the desired servicing has been performed with respect to a first blade, the removable winch may be removed from anchor point 121. If only one blade required servicing then the winch mechanism and 125 and/or winch 120 may be stored or otherwise taken to another wind turbine for use elsewhere. However, if a second blade (or any number of further blades) required servicing or if further servicing on other blades 10 is desired, the winch mechanism 125 may be re-positioned to a new position and/or configuration for the desired servicing. For example, removable winch 120 may be mounted on another anchor point 121 for servicing of one of the other two blades that have not yet been serviced in FIG. 4A. Depending on specific features of the wind turbine 2 and the turbine hub 12, the turbine hub 12 may be rotated so that the anchor point 121 of desired mounting of the winch 120 is in the top (twelve o'clock) position and then the removable winch 120 may be mounted on the ring 121. Alternatively, the removable winch 120 may be mounted on the desired ring 121 and then the turbine hub may be rotated to move the ring 121 and mounted winch 120 to the top position to allow for servicing of the blade (or a portion of the blade) on an opposing side of the turbine hub 12. After rotation and repositioning, servicing may proceed as described above. If further, blades need to be serviced (here the third blade 10), movement and relocation of the winch mechanism 125 including winch 120 may proceed accordingly as described.

The configuration of the wind turbine and servicing methods include several desirable features. First, only a single winch 120 is needed to service any and all blades 10 of the wind turbine 2. Relatedly, the winch mechanism 125 or winch 120 may be moved between blades, between wind turbines 2 and between wind farms, etc., as needed. Thus, less capital investment in servicing equipment may be required to service wind turbines 2. Also, the removable winch as described does not need to be stored in the turbine hub or even with any particular wind turbine 2. Rather, the winch mechanism 125 may be brought to the turbine for specific servicing. Lastly, the described winch mechanism 125 includes traits that allow for more desirable wind turbine 2 designs. The location of the winch 120 as described allows for AC power to be temporarily provided to the winch mechanism 125 from the nacelle 8. The nacelle typically houses this power and providing power from the nacelle is rather easy compared to other manners of providing power as is required in other servicing methods and structures.

While FIGS. 4A-B illustrate servicing of a portion of a blade 18, the servicing methods and structures described anywhere herein may be applied to service (install, repair, remove etc.) an entire blade 10. Thus the methods and structures described herein may be preferable to certain conventional installation methods using large expensive equipment like large cranes. To the extent further equipment is required, the equipment may be smaller in size and thus costs are reduced in performing the described servings and methods.

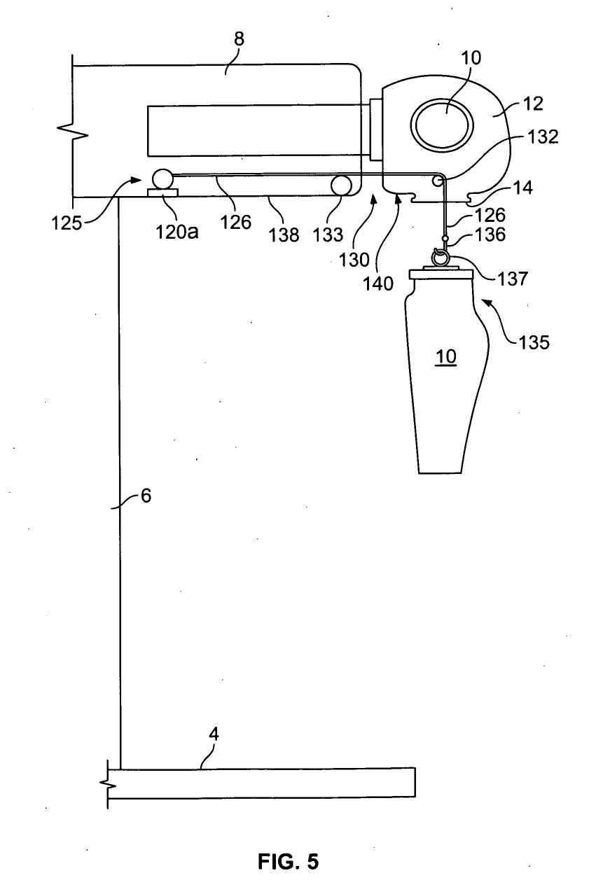

Like FIGS. 4A-B, FIGS. 5-7 are illustrative enlarged diagrams of various configurations and arrangements for servicing a turbine blade 10. Further, FIGS. 5-7 illustrate exemplary configuration and arrangements for servicing a turbine that may exist exclusively of one another or a single wind turbine may be outfitted to be used in all three configurations. For ease of explanation FIGS. 5-7 demonstrate the described methods and structures with respect to an entire fixed length blade. However, as described above, these methods and structures are applicable to a portion of a blade (e.g. blade tip), to variable length blades and other technology known in the art relating to wind turbines.

FIG. 5 illustrates a wind turbine 2 with one of the blades 10 in a removed state. As shown, winch mechanism 125 may be used to service the blade 10 including (repair, removal, installation, replacement etc.). Here, winch mechanism 125 is illustratively shown as including a winch 120a, cable 126, nacelle pulley 133, hub pulley 132 and securing mechanism 135. In the configuration of FIG. 5, winch 120a is housed in the nacelle 8 and is structurally supported and held in place by the bedplate 138 of nacelle 8. However, in other configurations winch 120a may be hoisted from the ground via cables and other lift structures and techniques and positioned as shown only when blade services is needed. The tower 6 may be configured with an opening or cavity to allow hoisting of the winch 120a into place. The cable 126 runs from winch 120a over nacelle pulley 133 and out of the nacelle 8. The cable continues on to the turbine hub 12 and is routed about hub pulley 132 changing the cable's direction approximately 90 degrees to a downward direction where the securing mechanism 137 is used to secure the cable to the blade 10. The securing mechanism 137 here consists of securing element 136 in the shape of a hook attached to a security element receiver 137 in the shape of a stirrup housed within the blade 10. As the cable passes out of the nacelle 8 and then enters what is considered the turbine hub 12, the cable passes through access port 130 of the wind turbine 12. Depending on the particular configuration of the wind turbine 12, access port 130 may be an access port for humans as is known in the art. Alternatively, access port 130 may be a distinct access port allowing service, monitoring and quality control of the winch mechanism during servicing. The access port 130 may also be utilized in varying the configuration of the winch mechanism to allow servicing of multiple blades 10 on the same wind turbine 12 in succession.

Similar as to that described with respect to FIG. 4, once a first blade has been serviced as desired, the cable 126 may be retracted. If winch 120a is a permanent fixture of the nacelle as is shown in FIG. 5, the winch 120a is left in the nacelle 8. If further blades 10 need servicing, the turbine hub 12 may be rotated and the winch mechanism utilized and re-configured as shown in FIG. 5 except that the particular blade (target blade) 10 being serviced will be different. Recognizable from FIG. 5, cable 126 may again be secured to the blade 10 as described. Depending on what type of servicing is occurring and whether the blade is to be raised or lowered, winch 120a is configured to retract or release cable 126 accordingly. The cable 126 is tensioned over nacelle pulley 133 and hub pulley 132. These pulleys help prevent problems with the winch mechanism 125 as the cable is prevented from getting caught in the nacelle 8 or the turbine hub 12. Further, destruction to components of the wind turbine 12 is also prevented as the pulleys 132, 133 guide the path of the cable 126 as the cable is tensioned between the weight of the blade and the connection to the winch 120a. The described systems, structures and methods may be used on new wind turbines or retrofitted for existing wind turbines. Some turbine designs include a winch 120a already housed at the rear of the nacelle 8 for raising and lowering various objects including maintenance supplies, replacement gear, boxes etc. Winch 120a illustrates an example of such a winch and the nacelle pulley 133 and turbine hub pulley 132 facilitate use of a winch 120a housed within the nacelle 8.

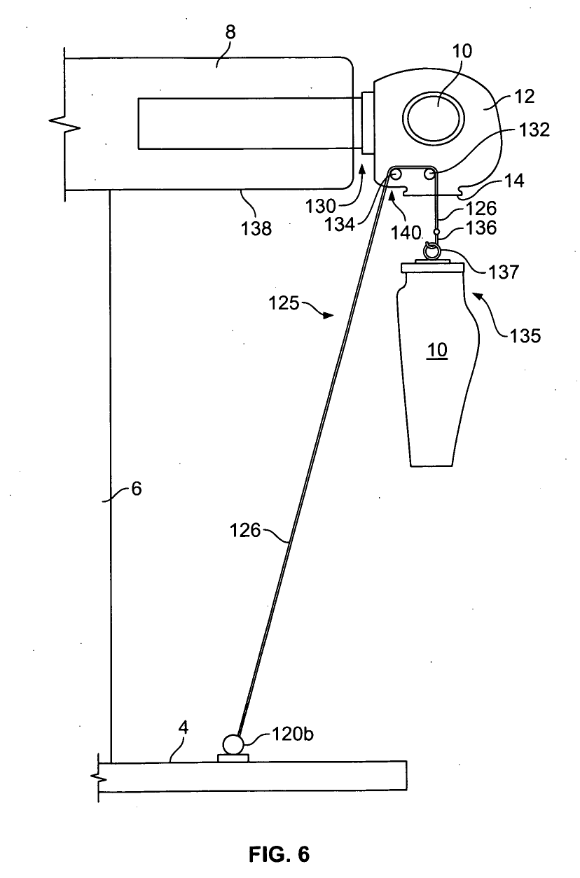

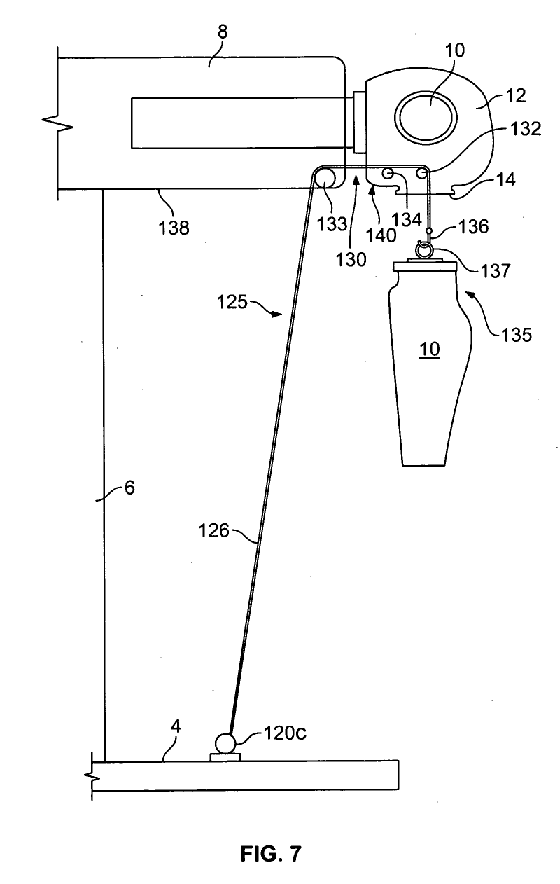

FIGS. 6 and 7 illustrate winch mechanism 125 configurations where the winch 120b and 120c are housed at the base of the wind turbine 2. Winches 120b and 120c may be permanent fixtures associated with the wind turbine or may be removable and repositionable on other wind turbines or other locations. In FIG. 6, the routing of cable 126 of winch mechanism 125 runs from winch 120b up to the turbine hub 12 through a special access port 140 and then on through a plurality of hub pulleys 132 and 134 housed within the turbine hub 12. Each pulley serves to change the direction of the cable, hub pulley 134 changing the direction from a generally vertical or vertical and horizontal direction, depending on dimensioning of the wind turbine 2 and location of the winch 120b on the base 4, to a horizontal direction to hub pulley 134. Hub pulley 134 facilitates the cable 126 again changing direction and continuing generally straight down through blade mounting flange 14 with the weight of the blade 10 pulling downward towards the ground. The special access port 140 may be any of a variety of openings, holes or other passageways, that allows the tensioned cable 126 to pass without causing injury, deformation or destruction to the wind turbine and in particular to the turbine hub 12. The special access port 140 may be outfitted with guide structures to align the cable 126 or reduce potential pathway movement to ensure the cable 126, when in use, runs in a desired orientation and position.

FIG. 7 illustrates a winch mechanism 125 configuration similar to that illustratively shown in FIG. 6. Winch 120c, like winch 120b, is housed at the base 4 of the wind turbine 2. Here, the cable 126 is routed through an opening or port in the nacelle and through a nacelle pulley 133 housed near the front of the nacelle 8. After running through the nacelle pulley 133 the cable 126 may be run through one or more pulleys in the hub of the turbine. As illustratively shown here, the cable may be run through hub pulleys 134 and 132 similar to the routing illustratively shown in FIG. 6. Alternatively, the cable 126 may be run only through hub pulley 132 as hub pulley 134 may not be present. Cable 126 may be run inside tower 6, or outside, as shown.

Generally speaking hub pulleys 132 and 134 and other pulleys positioned as desired consistent with the methods and structures described here may be fixed or removable. Whether removable or fixed, the pulleys (and other winch mechanism 125 components) may be accessed, installed or removed via ports such as special access port 140 or other similar ports, holes or openings in the wind turbine 2. While winch characteristics may vary according to use requirements and physical configurations of features of the wind turbine, it is recognized that winches 120b and 120c may be winches of significant size and strength as base positioning of the winch enables the winch to have few, if any, size or weight restrictions. Thus, a winch of immense size, strength, speed or efficiency may be positioned at the base 4 of the turbine. Upon completion of servicing of the blades 10 of a particular wind turbine 2, the winch may be moved to another wind turbine 2 nearby or located anywhere, and the described methods may again be performed. Accordingly, a single winch 120b or 120c may be used to service a number of wind turbines 2.

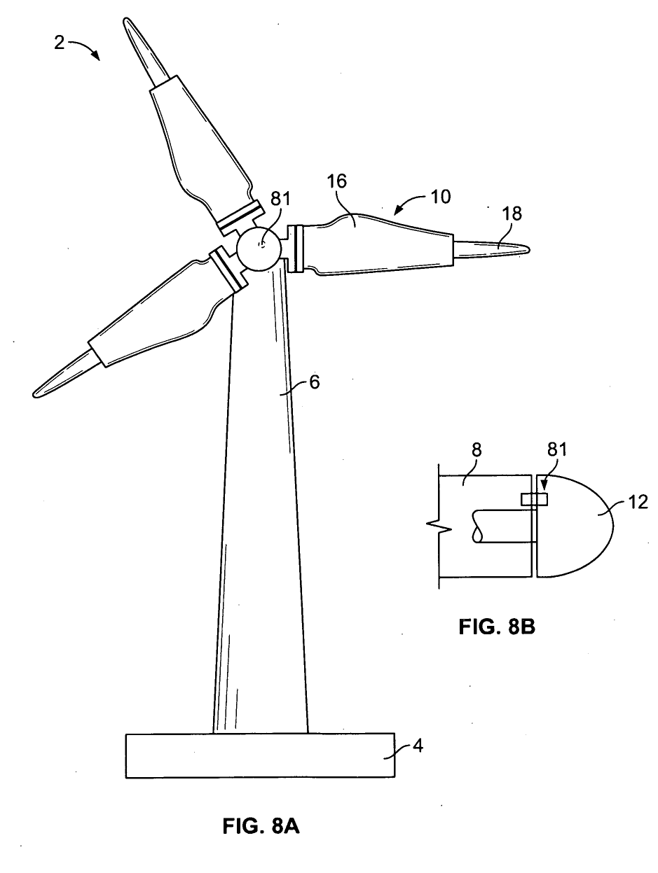

Consistent with the general method and apparatus described above an arrangement of a further illustrative example of replacement of a tip 18 of a variable length wind turbine blade 10 is described to further demonstrate the principles of the invention. FIG. 8 illustrates the described arrangement and configuration. For ease of explanation the following vocabulary may be used to illustratively describe elements and features of the wind turbine 2 and the components of the replacement mechanisms in the below example/arrangement.

Hub Locking Pin: A safety pin that locks the turbine hub, preventing unwanted rotation while servicing a turbine

Inboard Bearing: The support bearing in the fixed blade section, located closest to the hub. It supports the extendable blade section.

Outboard bearing: The support bearing in the fixed blade section, located furthest from the hub. The extendable blade section is held in the fixed blade section by the inboard and outboard bearings. These bearings prevent tip motions in all directions except for longitudinal sliding which changes the total length of the blade.

Retraction Rope: The main working rope that retracts the tip. It may be a multi-part line to reduce winch loading.

Blade Motion Winch: The main winch permanently installed in the wind turbine, it may be used to extend and retract the extendable blade section.

Service Rope: The rope attached to the service winch. This rope is long enough to reach from the hub, out through the fixed blade section, to the ground.

Service Winch: A small winch that can be carried out to the hub and placed to lower tips one at a time.

Sheave Support Plate: The mounting plate at the root end of the extendable blade section. It holds the sheaves for the extension and retraction ropes. It also may interface with the inner bearing thereby preventing the tip from moving further outwards than the normal fully extended position. The sheave support plate is removed to allow tip replacement.

Tag Lines: Auxiliary ropes used by workers to control a load as it is being raised or lowered

Tip Extension Rope: A rope that pulls inward as the retraction rope is fed out. The tip extension rope may extend to a sheave at the tip of the fixed blade section, and serves to pull the tip out. The tip extension rope is typically in service when extending the tip at times when the rotor (hub) is not rotating.

While various components may be utilized to perform the described method including the particular arrangement and method illustrated in FIGS. 8A-B, certain components are described to further illustrate the principles. The tip replacement shown in FIGS. 8A-B may be accomplished, for example, by several components. Among the illustrative components that may be used are: (1) Service winch—While service winches vary in characteristics and features, one example of an acceptable winch is a 1500 lb capacity winch when used with a hub height length of 200′ of Techron (11,000 lb breaking strength) rope. (2) Open end and/or crescent wrenches—The wrenches may be selected to match the sheave plate mounting bolts. (3) Come along—For example, a 1 ton come along or other suitable hand hoist may be utilized. (4) Rope grip—The rope grip may be for a suitable size rope. Here, in this arrangement, a ⅝″ rope may be utilized in light of the other weight and height characteristics described. (5) Lifting eye—The lifting eye may be used that is selected to fit the bolts of the root tip. Among the sizes that are used and known in the industry are ¾″ lifting eyes. (6) Safety hook—A safety hook may also be used in the described arrangement to attach the service rope to the lifting eye as will be described. Among the suitable sizes is a 1 ton safety hook, however, other sizes may be utilized. (7) Remote release (removable) attachment points and attached tag lines may be used in the described arrangement. The remote release attachment points and tag lines facilitate safe handling of a blade or portion of a blade, and may be used to increase safety of repair personnel and/or reduce cost of repairs as personnel can be prevented from performing dangerous maneuvers at extreme heights of the wind turbine. Also, the cost of bringing in a large crane can be prevented through use of the remote-release attachment points and tag lines as will be described.

FIG. 8A illustrates a wind turbine 2 in which a variable length extendable blade section 18 is to be replaced. In an initial portion of the replacement process, the turbine hub 12 is rotated so the blade 10 targeted for repair (target blade) is moved to a horizontal position (generally parallel with the horizon) and pitched flat to facilitate a human's ability to maneuver within or upon the blade 10. For example, the blade 10 is positioned horizontally so a service person can crawl towards the tip with less risk of sliding, falling, or receiving injury. The hub is then mechanically secured with a locking pin 81 to prevent unwanted rotation. Locking pin 81 passes through holes in the nacelle 8 and the hub 12, as shown in FIG. 8B, so the hub 12 cannot rotate.

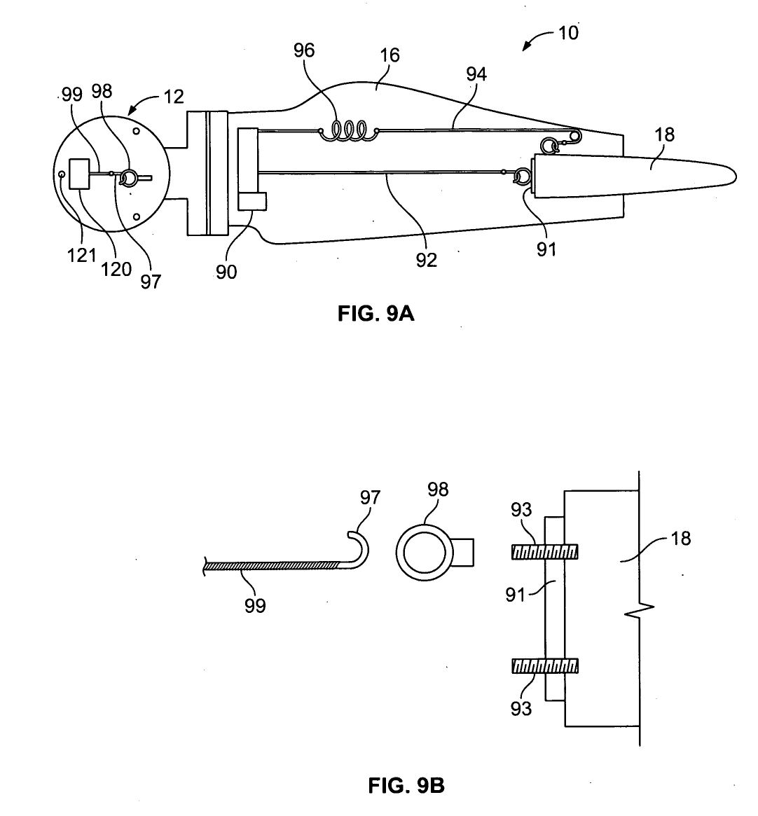

The tip replacement process continues as is shown in FIGS. 9A and 9B by moving the extendable blade section 18 to its shortest position and locking out the blade motion winch 90 so it cannot be moved. Locking out the blade motion winch 90 provides safety for repairmen and/or wind turbine operators. After the blade motion winch 90 has been locked out, and the hub is pinned to prevent rotation, the turbine hub 12 may be safely entered with selected tools as well as the service winch 121. Among the activities that may be performed after a serviceman enters the turbine hub 12 are inspection of the ropes as work is performed on them. This may be continually done throughout the process to ensure safety of all involved and may also help prevent harm to the blade 10 and other components of the wind turbine 2.

The blade motion winch 90 may be double wound, such that the retraction rope 92 is pulled in at the same time as the extension rope 94 is fed out. The extension rope may have a tension mechanism 96, illustratively depicted as a spring in FIG. 9A. In continuing the process of extendable blade section 18 replacement, tension may be removed from the blade tip extension rope 94. For example, one or more tension mechanisms 96 associated with the tip extension rope 94 may be unlocked and backed off. This action is similar to backing off the spring of a garage door when performing maintenance. In this example, as much as 250 lb of tension or more may be removed. The amount of tension removal may be varied from arrangement to arrangement depending on various wind turbine characteristics etc. Additionally, in anticipation of rotation of the wind turbine hub 12 later in the process for further work during replacement, the loosened ends of the extension rope 94 may be secured, fastened or otherwise housed in temporary fashion to the fixed section of the blade 10 to prevent the loosened ends from falling or otherwise freely moving about when the wind turbine 2 will be rotated, as described later.

The service winch 120 may now be secured to the frame of the blade motion winch 90, or to any other attachment point 121. FIG. 9A shows an attachment point 121 located in the hub 12, but it could also be located in the blade 10. It is also may be advisable to verify that the safety hook 97 and lifting eye 98 are attached to the end of the service rope 99. The service rope 99 may then be pulled out from the service winch 121 and the service person may move (e.g. crawl) out into the fixed blade section 16 to the root end of the movable blade section 18. Here, the sheave support plate 91 may be removed from the extendable blade section 18, which detaches the retraction rope 92 from the tip. The sheave support plate 91 is then temporarily secured to the fixed blade section 16 to prevent uncontrolled motion when the blade 10 is tipped to a vertical position. Also, the service rope 99 may be attached to the root end of the movable blade section 18 using one of the sheave support plate mounting bolts 93 as shown in FIG. 9B. The extension rope 94 is detached from the extendable blade section 18 so it is free to be lowered to the ground. The loose end of the extension rope 94 is secured to the fixed blade section 16 to prevent uncontrolled motion when the blade 10 is tipped to a vertical position. The service person would then make their way out of the blade 10 and hub 12 after these and any other related tasks have been performed. To confirm safety, a check can be performed as desired or needed, including such items as: the service winch 120 is secure; the ends of the extension rope 94 are tied off, and any tools have been placed in a work bucket or related device.

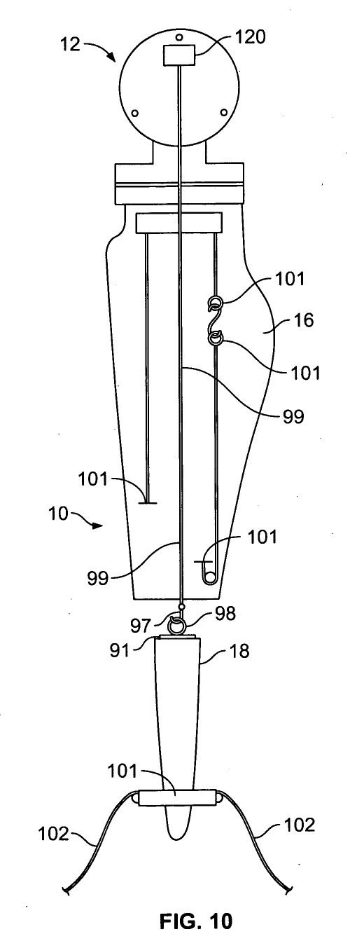

The work bucket is then removed from the hub 12 which is unpinned to allow rotation. The hub 12 is then rotated until the target blade is pointing vertically downward as illustratively shown in FIG. 10. The hub is re-pinned and the service person may return to the hub. With loose parts secured to the fixed blade section 16 at locations 101, the movable blade section 18 will now be free of its connection to the turbine and solely held aloft by the service rope 99. Accordingly, the service winch may be used to lower the movable blade section 18 to the ground.

Now that the original, cracked, or broken movable blade section 18 has been removed from the wind turbine, it is likely a new or replacement tip will be put into service such that the wind turbine can quickly be put back into service for power generation. Generally, speaking the process and methodology of raising a new or replacement tip into place may be considered the reverse of the process and methodology of lowering the extendable blade section as illustratively described above. For ease of understanding and further clarity, an illustrative method for raising the replacement (or even a new movable blade section 18 if constructing a wind turbine) is described below.

Prior to raising the new or replacement extendable blade section 18, the remote-release attachment points 101 and tag lines 102 are attached to the tip end of the extendable blade section 18, as these features may be used to steady the tip and keep it oriented as it is pulled up to the fixed blade section for attachment. The new extendable blade section 18 is then connected to the service rope 99 and safety hook 97 using the lifting eye 98 attached to one of the sheave plate bolts 93. In raising the new tip (see FIG. 10), it will be oriented to slip into the fixed blade section 16 by pulling on the tag lines 102. As needed, for safety reasons, tip progress may be verified. For example progress may be monitored by watching the controller output lights as in one arrangement these lights will be illuminated when the embedded targets in the extendable blade section 18 pass the sensors mounted in the fixed blade section 16. Other specific arrangements known in the art may be utilized as well.

Once the extendable blade section 18 is pulled into the fixed blade section 16, the service person again exits the blade 10 and hub 12 with all hand tools, so that the turbine can be rotated until the target blade is again horizontal. Verifying that the hub 12 is pinned to prevent rotation, the service person enters the hub 12 again to disconnect the service rope 99, re-attach the extension rope 94 and retraction rope 92, and remove the service winch 120. After verifying proper operation of the variable length blade 10, the tag lines are dropped via the remote release functionality and the tools are gathered up and the hub is exited by the servicemen. Finally, hub 12 is unlocked and the turbine 2 may be returned to service or the wind turbine may be rotated so the next blade is in position for servicing as described above. As can be seen from these examples, either a portion of a blade, 18, 16, or an entire blade 10 can be removed and replaced using these techniques.

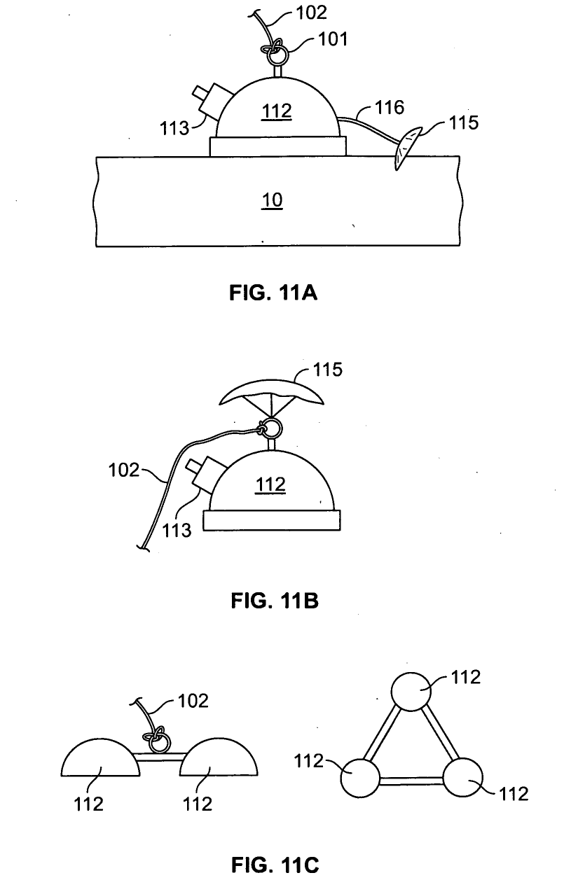

In order to safely handle a blade or part of a blade while it is hanging from the service rope, tag lines are used. However, once a blade is installed, it is difficult to remove the tag lines. For this reason, remote-release attachment points 101 are used in this blade replacement system. FIGS. 11A, and 11B show a method of temporarily fixing attachment points to a blade 10, or portion of a blade 18, 16. Suction cups 112 with radio controlled bleed valves 113 hold the remote-release attachment points 101 securely to the surface of the blade 10. Once the blade has been lifted into place and secured, a radio signal opens the bleed valve 113, and the suction cups lose their grip, dropping the remote-release attachment points 101 to the ground, along with the attached tag lines 102. In order to prevent damage from the fall, a small parachute 115 may deploy. This can be accomplished by holding the parachute 115 with a clip 116 against the blade 10. When the remote-release attachment points 101 drop away, the parachute 115 is free to open and allowed to function as a drag increasing parachute of the types of parachutes that are commonly known and encountered. When additional strength is needed, multiple suction cups 112 can be ganged together as shown in FIG. 11C. Also, multiple units can be used.

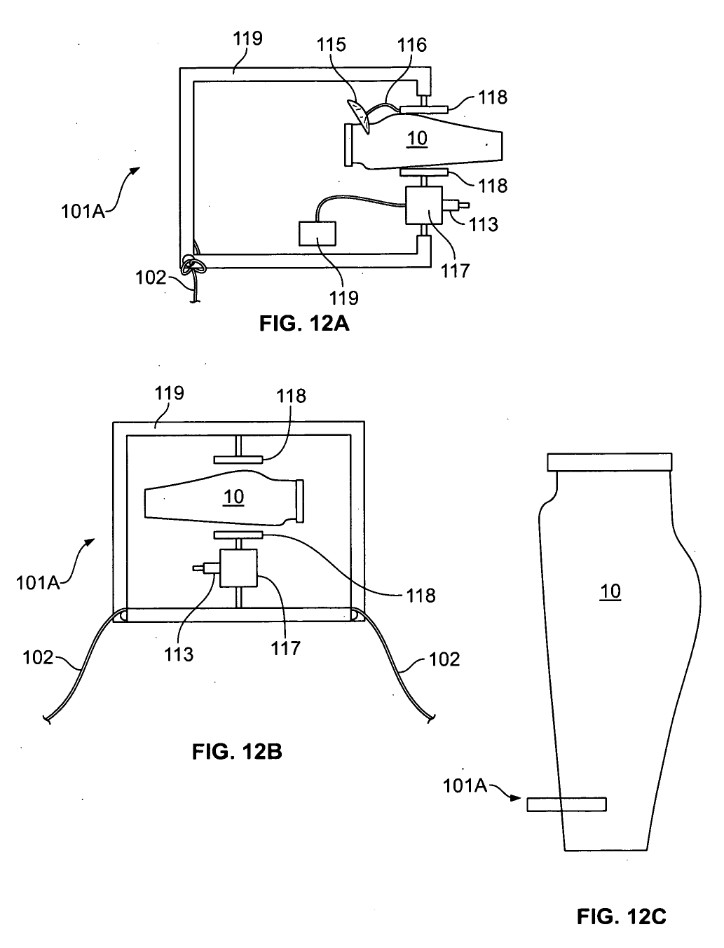

FIGS. 12A and 12B illustrate similar devices, but with the further trait of a longer, more secure deployment time. Whereas the suction cup device could lose its grip due to a very small leak at the suction cup 112, an air pressure device can hold indefinitely as it is less likely to lose its grip. Similar to the previous example, a remote-release attachment point 101A can be released with a radio controlled bleed valve 113. The force that holds the remote-release attachment point 101A to the blade 10 in this case is supplied by a small air cylinder 117. Pressurizing the air cylinder 117 forces pads 118 against the blade 10. Again, a parachute 115 may be held with a clip 116 until the device is dropped. Either the suction or air pressure activated remote-release attachment point 101A may include a receiver 119 to add volume to the system. Added volume increases the amount of time the device will remain attached to the blade 10, by overcoming small air leaks. The frame 119 may be a ‘C’ shape or a closed shape. Either one will fall away from the blade easily when the blade is in the vertical position shown in FIG. 12C. The frame 119 may provide more than one attachment point for tag lines 102.

While the invention has been described with respect to specific examples including presently preferred modes of carrying out the invention, those skilled in the art will appreciate that there are numerous variations and permutations of the above described systems and techniques. Thus, the spirit and scope of the invention should be construed broadly as set forth in the appended claims.

We claim:

1. A wind turbine comprising:
a plurality of blades operably connected around a turbine hub, wherein the wind turbine is configured to house a winch mechanism for removing a portion of a blade, the winch mechanism including a winch, a cable, and a securing element.

2. The wind turbine of claim 1 wherein the turbine includes mounting hardware for mounting a winch on the turbine hub to facilitate removal of the portion of the blade.

3. The wind turbine of claim 2 wherein the mounting hardware includes plurality of rings, each ring configured for mounting a winch for use in removing a portion of a particular associated opposing blade.

4. The wind turbine of claim 3, wherein the plurality of blades are variable length turbine blades and the portion of the blade is an extendable blade tip of the variable length turbine blades.

5. The wind turbine of claim 1, wherein the winch is housed within a nacelle.

6. The wind turbine of claim 5, wherein the turbine hub includes a pulley.

7. The wind turbine of claim 6, wherein each of the nacelle and turbine hub houses a pulley configured to receive the cable and to facilitate removal of the portion of the blade.

8. The wind turbine of claim 1, wherein the winch is housed at a base of the wind turbine.

9. The wind turbine of claim 8, further comprising a plurality of pulleys housed in the turbine hub.

10. The wind turbine of claim 1, wherein the portion of the blade includes a securing element receiver complimentary in configuration to the securing element.

11. The wind turbine of claim 10, wherein the securing element is a hook.

12. The wind turbine of claim 11, wherein the securing element receiver is one of stirrups and hooks.

13. The wind turbine of claim 1 further comprising mounting hardware housed on a surface of the turbine hub at a plurality positions, each of the plurality of mounting hardware positions being positioned and configured to house a winch, the winch being configured to both lower and raise the portion of the blade on an opposing side of the turbine hub for removal and installation.

14. The wind turbine of claim 1 further comprising a plurality of positions for housing the winch thereby enabling the cable of the winch mechanism to be routed through the pulley in a plurality of distinct paths dependent upon positioning of the winch.

15. The wind turbine of claim 14 wherein the plurality of positions for housing the winch include within the nacelle and on the base.

16. A method for removing a portion of a blade of a wind turbine, comprising the steps of:
attaching a securing element to a portion of a blade;
disconnecting the portion of the blade from a turbine hub; and
supporting and lowering the disconnected portion of the blade using a winch mechanism, the winch mechanism including a winch housed by the wind turbine and operably connected to a securing element through a cable and a pulley.

17. The method for removing a portion of a blade of a wind turbine of claim 16, wherein the securing element is a hook.

18. The method for removing a portion of a blade of a wind turbine of claim 17, wherein the portion of the blade houses a securing element receiver and the securing element is configured to attach to the portion of the blade by engaging the securing element receiver.

19. The method for removing a portion of a blade of a wind turbine of claim 18, wherein the securing element receiver is one of stirrups and hooks attached to blade bolt holes.

20. The method for removing a portion of a blade of a wind turbine of claim 16, wherein the portion of the blade is an entire turbine blade.

21. The method for removing a portion of a blade of a wind turbine of claim 16, wherein the portion of the blade is a tip portion of a variable length turbine blade.

22. The method for removing a portion of a blade of a wind turbine of claim 16, wherein the winch is powered by AC power provided from the nacelle.

23. The method for removing a portion of a blade of a wind turbine of claim 16 further comprising the steps of:
mounting the winch mechanism on a first wind turbine;
dismounting the winch mechanism after the blades of a first wind turbine are repaired;
re-mounting the winch mechanism on a second wind turbine;
attaching a securing element to a portion of a blade of a second wind turbine;
disconnecting the portion of the blade from a turbine hub of the second wind turbine; and
supporting and lowering the disconnected portion of the blade of the second wind turbine using the winch mechanism.

24. A method for installing a portion of a blade of a wind turbine, comprising the steps of:
attaching a securing element to a complimentary blade securing element receiver housed by a portion of a blade;
attaching a portion of the blade to the turbine hub using a winch mechanism, the winch mechanism including a winch operably connected to the portion of the blade through the securing element to support and raise the portion of the blade; and
operably connecting the portion of the blade to the turbine hub.

25. The method for installation of a portion of a blade of a wind turbine of claim 24, wherein the portion of the blade is a full turbine blade.

26. The method for installation of a portion of a blade of a wind turbine of claim 25, wherein the turbine blade is operably connected to the turbine hub with a plurality of bolts positioned around a cross-section of a blade root of the turbine blade.

27. The method for installation of a portion of a blade of a wind turbine of claim 24, wherein the portion of the blade is a tip portion of a variable length blade.

28. A securing device for a structure at an elevated height comprising:
a body housing a release mechanism configured for releaseably securing a tag line attachment point to a hoisted load and a remote control in operable communication with the release mechanism such that communication from the remote control will cause the release mechanism to move from a secured state to a released state.

29. The securing device of claim 28, further comprising a remote controlled valve housed on the body, wherein the remote controlled valve is configured to cause release of the attachment point from the load upon activation by communication from the remote control.

30. The securing device of claim 29, wherein the release mechanism includes a vacuum cup.

31. The securing device of claim 29, wherein the release mechanism includes an air cylinder.

32. The securing device of claim 29, further comprising a drag increasing device housed on the body.

33. The securing device of claim 32, wherein the drag increasing device is deployable.

34. The securing device of claim 33, wherein the drag increasing device is a parachute configured to include a non-deployed state and a deployed state.

35. The securing device of claim 28, wherein the hoisted load includes a portion of a wind turbine blade.

36. The securing device of claim 35, wherein the release mechanism is configured to releaseably secure a tag line attachment point to the portion of a wind turbine blade without causing variation to airflow characteristics of the wind turbine blade.
